(19) United States
(12) Patent Application Publication
(10) Pub. No.: US 2020/0067928 A1
(43) Pub. Date: Feb. 27, 2020

(54) System and Method for Providing Stashed Service in Network and Cloud based Filesystems and Online Services

(71) Applicant: Anirudha Sahoo, North Potomac, MD (US)

(72) Inventor: Anirudha Sahoo, North Potomac, MD (US)

(73) Assignee: Anirudha Sahoo, North Potomac, MD (US)

(21) Appl. No.: 16/237,488

(22) Filed: Dec. 31, 2018

Related U.S. Application Data
(60) Provisional application No. 62/722,931, filed on Aug. 26, 2018.

(51) Int. Cl. H04L 29/06; G06F 9/455; G06F 16/182

(52) U.S. Cl. CPC H04L 63/102; H04L 63/08; G06F 2009/45595; G06F 16/182; G06F 9/45558

(57) ABSTRACT

The present invention relates to the field of network and cloud based systems which provides an online user with a transitory offline services for network and cloud based file systems and online services comprising: a full service system, which provides the user with full online services when required by the user; a stashed service system which provides a system to the user which temporarily stashes away files/file systems or online services offline, when not in use; and service provisioning logic system which retains the information and updates the user of the then available mode of the service system.

### FIELD OF INVENTION

The present disclosure relates to the field of network and cloud based systems. More specifically, this invention relates to online filesystems and online services which could possibly be resident in a cloud.

### BACKGROUND OF THE INVENTION

Network and cloud based file systems (e.g., google drive, dropbox) containing personal and important documents (e.g., medical, tax documents) suffer from concerns of privacy and security. Thus, storing and transporting file systems over cloud based system are increasingly subject to attacks making online filesystems vulnerable. Besides, for personal and sensitive online services (e.g., online credit card, bank account services) the ability to stash them, when not in use, needs to be embodied. Hence, there is a need for service providers to provide Stashed Service. To ensure a secured system of file transfer and storage over the cloud, cryptographic file system remains a viable alternative for mitigating the danger of exposing data by using encryption and integrity protection methods and guaranteeing end-to-end security for their clients. Thus, malicious users would not be able to get access to user's data when it is stashed away. Such a process is considered useful for important documents, bank and credit card accounts and other online services which may not be accessed for a relatively long periods, e.g., a credit card account or an email account or a personal document which is not used regularly.

Various prior arts that discusses about various methods for securing cloud based file systems are

U.S. Pat. No. 9,015,483B2, “Method and system for secured data storage and sharing over cloud based network” provides a method and system for secure data storage and sharing over a cloud based network. The method comprises installing a client application on a user device, authenticating a client application user, extracting content from a data source, obtaining content sharing information from a content storage provider, sending a content distribution list and a content usage policy to an application server, encrypting the content by the client application, creating and sharing a secure content file, decrypting the content file, finding the content usage policy and sharing information from the content file, obtaining an updated content usage policy from the application server, authenticating the content recipient using an authentication mechanism, verifying the identity of the content recipient using an identity resolution mechanism, rendering the secure content file to the recipient, enforcing the content usage policy and sending content usage logs to the application server.

U.S. Pat. No. 9,135,458B1 titled, “Secure file transfer systems and methods” relate to file transfer systems and/or methods that enable a single provider to offer to different customers customizable file transfer solutions that are secure, scalable to handle enterprise-level amounts of data, and able to meet customer-specific needs even though such needs are not necessarily known in advance. Once initially set up, the file transfer solution of certain example embodiments delegates management of the customer-specific instances of the solution, optionally in a sub-delegatable manner and, thus, the single provider need not be consulted after specific initial instance deployment time (e.g., for security management and/or other routine maintenance issues).

U.S. Pat. No. 9,767,299B2 titled “Secure cloud data sharing” discloses a system and method for sharing an encrypted file stored on a cloud server. In certain embodiments, the method includes generating a file key associated with the encrypted file stored in the cloud server; generating a share message, the share message including the generated file key and identifying a recipient user and the encrypted file stored in the cloud server; encrypting the file key using an identification key of the recipient user to generate a share key; storing the share key in the cloud server; notifying the recipient user of the encrypted file and share key stored on the cloud server; retrieving the encrypted file and the share key from the cloud server; decrypting the share key using the identification key of the recipient user to reconstruct the file key; and using the reconstructed file key to decrypt the encrypted file.

US20130080765A1 titled, “Secure cloud storage and synchronization systems and methods” discusses a secure cloud storage and synchronization system and method is described that provides, among other things: (1) local password recovery, including a mechanism by which the user of the system can recover their password without having stored it on a remote server; (2) secure, private versioning of files, including a mechanism to privately store a version history of files on one or more remote servers in such a way that it is technically infeasible for anyone other than the legitimate owner to access any component of the file history; (3) secure, private de-duplication of files stored on one or more remote servers that reduces storage requirements by allowing for the storage of a single file when there are duplicates, even across users; and (4) secure, private sharing of files between users of the system that allows one user to share a file on the “cloud” with another user without deciphering or transporting the file.

Though the features of the above inventions match with respect to secured access of data over the cloud system, the inventions do not allow the user the freedom of various degrees of such accessibility. Such an option allows accessibility of a typical set of required data. The rest of the data which are not required at the same point of time are to remain inaccessible, to increase security of the same.

The present invention tries to plug the deficiency by introducing the aspects of accessing data vide full service system as well as in the form of stashed service.

### BRIEF SUMMARY OF THE INVENTION

An aspect of the invention is to provide a system to the user which temporarily stashes away files/file systems or online services offline, when not in use, referred to as the stashed services of the present invention.

Another aspect of the present invention is to provide a system which provides the user with the option to avail the full online services when required by the user referred to as full service mode in this invention.

Another aspect of the present invention is to provide the user with a mandatory option of switching from the stashed service mode to the full service mode.

Yet another aspect of the present invention is to provide the user with a mandatory option of switching from the full service mode to the stashed service mode.

Still another aspect of the present invention is to provide a secure system where the system is able to switch/transition between the “stashed service mode” and the “full service mode” or vice versa only after the user logs in with successful authentication.

Another aspect of the present invention is to provide a system having a multifactor authentication system wherein, the user may be asked a set of pre-registered security questions or a generated passcode sent to the user's registered mobile phone is required to be entered, while transitioning from the full service mode to the stashed service mode or vice versa.

A further aspect of the present invention is to provide “granularity” of stashed services where only a part of the online services may be chosen for “stashing away” with the rest of the services being in the full service mode.

### BRIEF DESCRIPTION OF DRAWINGS

The present description will be better understood from the following detailed description read in light of the accompanying drawings, wherein like reference numerals are used to designate like parts in the accompanying description.

FIG. 1 is a block diagram of the user interface of the system which implements the present invention.

FIG. 2 is schematic representation of the logical view of the system of the present invention.

FIG. 3 is a flowchart representing the system of the present invention.

FIG. 4 illustrates the switch between the stashed state and the full service state through valid authentication of the present system.

FIG. 5 represents an embodiment of the present system using the Network File system (NFS) for providing the services of the present invention.

FIG. 6 represents an embodiment of the present system using the Web Services for providing the services of the present invention.

FIG. 7 represents an embodiment of the present system using the Virtual Machine (VM) for providing the services of the present invention

### DETAILED DESCRIPTION

The present invention discloses a method and system for providing a novel service to the users of networked and cloud based file systems and online services, which temporarily puts the selected services of the users offline, herein after referred to as “Stashed Service”. The “Stashed service” of the present invention, functions by holding the file systems or online services of the user offline, when the user is not working with those services or file systems temporarily. This enables providing the online services or the file systems of the user with more security, thereby ensuring the privacy of the user's file systems, personal documents and information (e.g., tax and medical documents). These file systems or online services may be taken offline physically or logically, depending on the design and architecture of the system.

The steps involve a user requesting instantiation of a set of virtual machines from a cloud computing environment, which can include a set of resource servers configured to deliver processor cycles, operating systems or components thereof, applications, input/output bandwidth, or other computing resources. Thereupon the cloud management system identifies the resources necessary to build and launch a set of virtual machines to the user's specification, and requests those resources from the set of resource servers. After populating the set of virtual machines from the cloud, the cloud management system inserts a token ID into one of the virtual machines to designate that machine as a management instance. An image of that machine can be stored in the cloud management system to represent the configuration of the set of virtual machines, which in some cloud environments cannot be stored to permanent storage.

Individual virtual machines built from that stored configuration can be identified by an IP address, serial number, or other identification. When the user, systems operator, or other administrator or entity wishes to update or reconfigure the set of virtual machines, the cloud management system can select another virtual machine to insert another token ID, reconfigure the operating system, software, processing, or other resources of that virtual machine as a second or further management instance, and repopulate a revised set of virtual machines to the updated specification. The original set of virtual machines can be permitted to operate or can be retired or terminated from the cloud. The revised management instance can be stored via the cloud management system, and the process of updating the configuration of the set of virtual machines can be repeated as many times as desired. The cloud management system can therefore build, launch and store copies of configuration images of the set of virtual machines, even in cloud environments where permanent storage is not available. These and other embodiments described herein address the various noted shortcomings in known cloud computing technology and provide a user or network operator with an enhanced set of management tools to identify, track and update sets of instantiated virtual machines.

In the above method, several technical attributes and their utility are hereby clarified to enable reflection of the novel aspects of the invention in an explicit manner.

SERVICE GATE: The Service Gate of the present invention is a subsystem (hardware and software) which acts as a “gatekeeper” to provide services to the user depending upon the request received from the user and upon successful authentication. In the present invention, the Service Gate is responsible for the following:
Validating the authentication information provided by the user
Keeping track of the “mode” the system is in (“Stashed Service” or “Full Service” state)
Checking the validity of the user's request, depending on the mode of the system and sending an error message accordingly. (For example, if a user sends a request which is valid only in “Full Service” state, but the system is in “Stashed Service” state, then Service Gate would reject the request and send an appropriate error message.)
Switching the system from one service mode to another (from “Full Service” to “Stashed Service” and vice versa) upon receiving request from the user with valid authentication.
Mapping the user's request before sending it to the subsystem for its proper implementation through any of the services provided by the present invention (e.g., web services, virtual machine).

Full Service: Is a functional module which implements the Full Service of the present system. This module provides the general online services which are essentially present today. For example, the current online banking system which provides facility of viewing current balance”, “viewing last x number of transactions”, “transfer funds” and many others.

Stashed Service: This module functions to ensure certain services to be temporarily put offline. Taking the online banking service as an example, a user may stash (or turn off) “fund transfer” feature, when the user is not in immediate need of that particular service (here “fund transfer” service). This makes it difficult for a fraudulent user to transfer funds from this stashed account. The stashed service also provides “granularity” of services, which means that any selected services can be put offline temporarily and the rest of the services operates online. In this example, the stashed service is only for “fund transfer” and all other services are left to operate as usual.

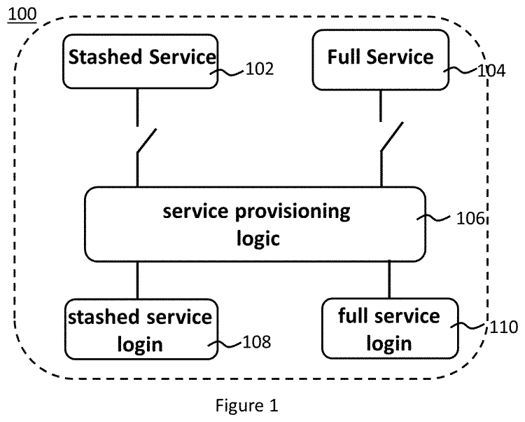

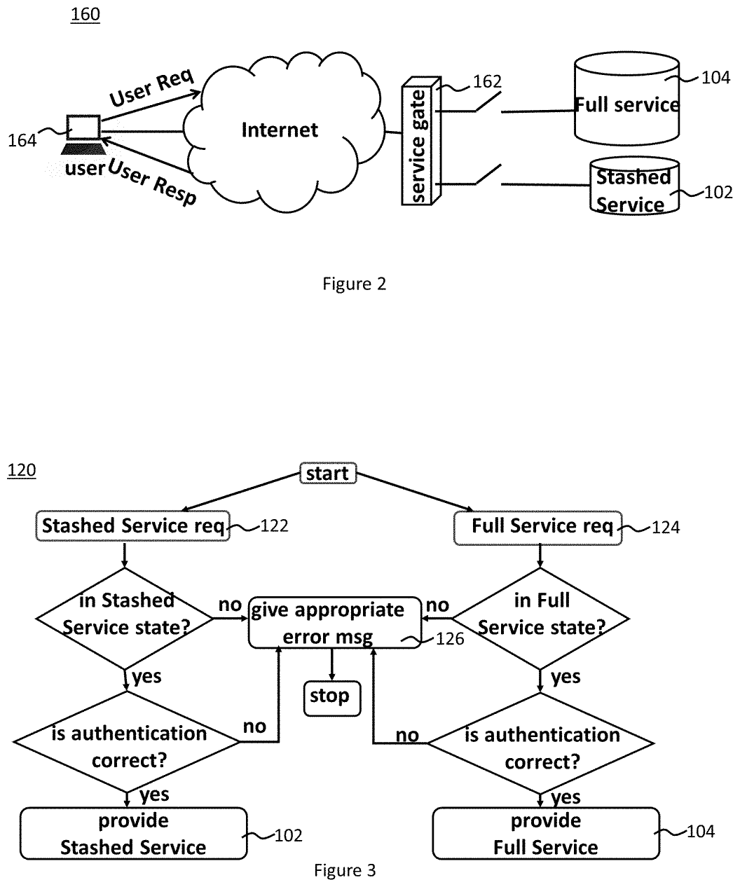

Referring now to FIG. 1, the system (100) of the present invention comprises of two services, the stashed service (102) and full service (104). Each of these services is provided with a login authentication code, stashed service login (108) for stashed service (102) and full service login (110) for full service (104) respectively. These services can be accessed by the user only upon providing a valid authentication which are described in more detail in FIGS. 2 and 3. Both the full service (104) and the stashed service (102) are provided with the option of switching to the stashed service and full service accordingly. When the services of the user are in full service (104) state, the user is unable to access the stashed services (104) and vice versa. To switch between the services a valid authentication is to be provided by the user.

FIG. 1 further illustrates the user interface of the present invention, in which the Service Provisioning Logic (106) is a functional module. This module retains information about the mode the system is in (whether in “Full Service” or in “Stashed Service” mode) and depending upon the present mode, it provides the login for the corresponding service. For example, when the user logs in, this module informs the user (for example, through a pop up message) about the mode, the service it is in (so the user would know what kind of service she can get from the system once she is logged in) and hence what kind of service is being provisioned for the user.

FIG. 2 represents a logical view of the system 160 and the role of service gate in intercepting the user's request and validating and subsequent accomplishment of the requests by the users. Upon receiving requests by the users via the internet, these are intercepted by the service gate (162) and depending upon the requests, one of the services (Full Service or Stashed Service) is enabled or the system changes its service from one to the other. Finally, the system generates an appropriate response to the user (164).

Authentication Process:

The system of the present invention requires authentication at two levels. Once when the user logs in to the services, and secondly when the user requests for transitioning from one service mode to another (herein from stashed service mode to full service mode or vice versa).

When the user first logs in and sends a request for Full Service 124, the system checks if it is in the Full Service state 144. If it is not, then appropriate error message 126 is generated. Otherwise, it checks if the authentication is correct. If not, appropriate error message 126 is generated. Otherwise, user is given access to Full Service 104.

The present invention provides, in the Stashed Services 142, one of the option as transitioning to the Full Service state 144. The authentication required to avail this service, is quite stringent and the system either asks the user a set of pre-registered security questions, or sends a passcode to the user's registered cell phone or goes through some other multi-factor authentication etc., before the user can avail the full services after transitioning from the stashed service mode.

Similarly, the Full Service mode 144, provides one of the option as transitioning to the Stashed Service state 142. The authentication required to avail this service is similar to as described above for stashed services.

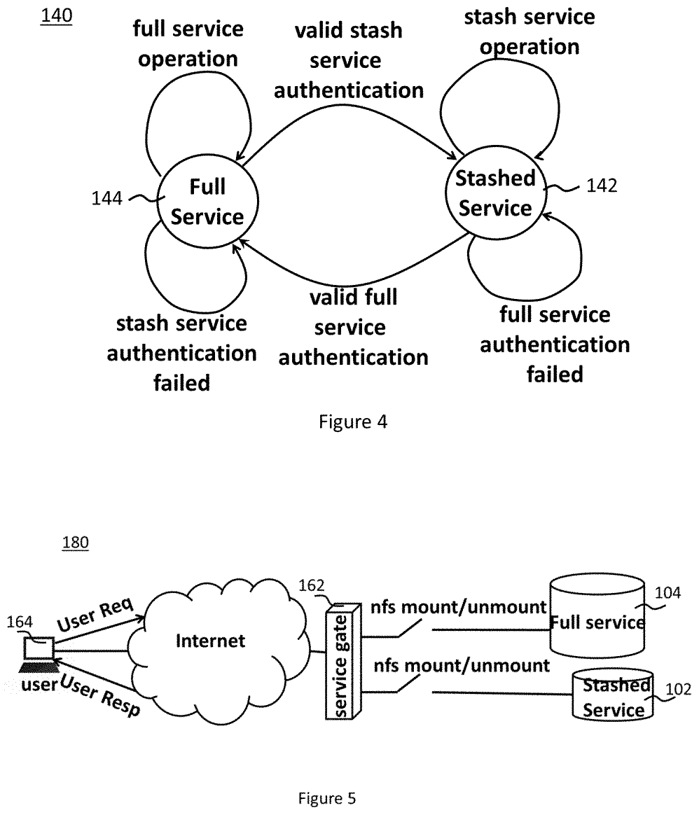

Further disclosed is one possible state transition 140 as shown in FIG. 4. When the system is in the Full Service state 144, upon receiving from the user a request for a Full Service operation (e.g., read/write a file), it stays in the same state 144. If the request received is for transitioning into the Stashed Service state, then the system enables the Stashed Service state 142 only upon receiving corresponding successful authentication, otherwise, the Full Service state 144 is maintained. Likewise, when the system is in the Stashed Service state 142, upon receiving from the user a request for a Stashed Service operation, it stays in the same state 142. If the request received is for transitioning into the Full Service state 144, then the system enables the Full Service state 144, only upon receiving corresponding successful authentication, otherwise, it stays in the Stashed Service state 142.

In an embodiment of the present invention, the implementation of Stashed Service may only provide mandatory service of switching to Full Service from the stashed service. In another embodiment, the implementation may also include read-only or some other limited service. Granularity of Stashed Service may also vary from one implementation to another. Some implementation may take the entire filesystem or online service to stashed mode, whereas some other implementation may provide the ability to take individual file or folder or individual attribute of the online service (e.g., money transfer of online banking) to stashed mode.

Also provided is one embodiment of the implementation of a system based on NFS mounted filesystem 180 shown in FIG. 5. When a particular service is requested by the user 164, then that service is enabled through NFS mount. On the other hand, if a service is to be disabled then it is done through NFS unmount. Note that this embodiment 180 is an example where the filesystem is physically attached to or detached from the Internet through NFS mechanism.

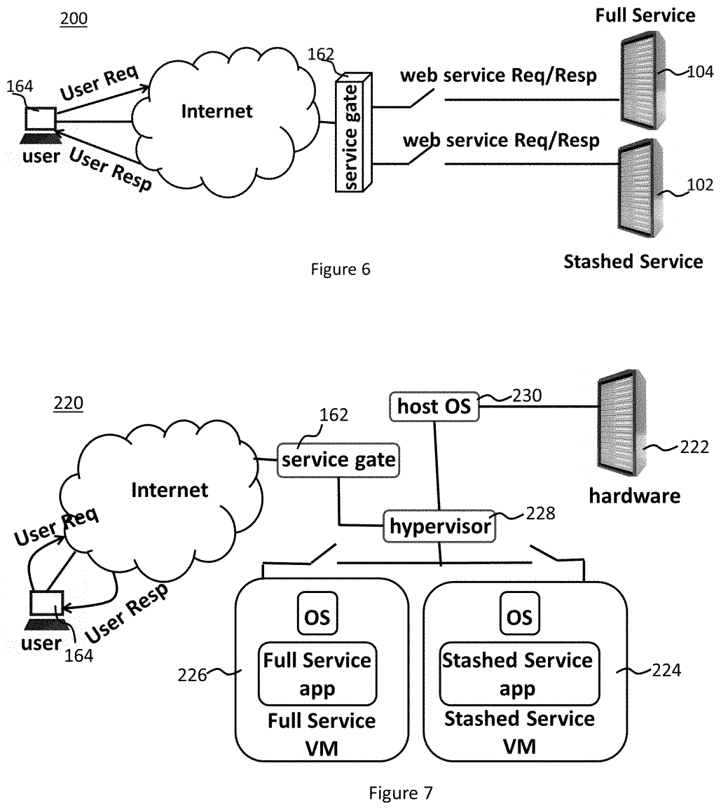

FIG. 6 shows the embodiment of a system 200 when the services are provided through Web Services. When a user requests for transitioning from one service to another, the Service Gate 162 does the switching appropriately. Depending on the current state of the system only one of the services stays online. A user request is mapped to an appropriate web service request by the Service Gate 162. Based on the request and the current state of the system Service Gate 162 dispatches the request to the appropriate web service. Likewise, the Service Gate 162 converts the corresponding web service response to an appropriate user response.

In another embodiment, services 220 can be provided using Virtual Machines (VMs) as shown in FIG. 7. The two services run in two different VMs. Depending on the current state of the system only one of the VMs remains online. If a user 164 requests to transition from one service to the other, the Service Gate 162 shuts down the current VM and brings the other VM online. For other requests from a user 164, the Service Gate 162 presents the request to the online VM and later relays the response it receives from the VM to the user 164.

A Full Service 104 can also be stashed by logically removing the service from the system. For example, even if the filesystem could still be physically connected to the system, enough logic (using the state information) will be put in the Service Gate 162 that will prevent users from accessing the filesystem. For example, any read/write into a filesystem will first come to the Service Gate 162, which will check if the filesystem is in Stashed Service state 142 or not. If it is, then the Service Gate 162 will block the read/write and return an error to the user.

Different implementations can provide services at different granularity. For example, the Stashed Service 102 could be provided for individual files or folders rather than for the entire filesystem. In case of online service, Stashed Service 102 could be provided only for a particular attribute of the service, e.g., transferring money out of an online bank account (i.e., when the “transfer money” service is in the Stashed State, one cannot transfer money from the account), whereas Full Service 104 could be provided to other attributes of the online services.

When the service is in the Stashed Service state 142, if the service needs to be online to execute a system-initiated transaction, then the system 100 could enable Full Service 104 momentarily, execute the transaction and put the service back to Stashed Service state 142. Alternatively, the system 100 could cache this request and any future requests and execute the transactions in a batch mode at a certain time of the day (e.g., midnight) by enabling Full Service 104 momentarily at that time and then putting the service back to Stashed Service state 142. An example of such a scenario is when a user puts her online bank account in Stashed Service mode, and she gets a direct deposit from her employer into the bank account.

The above specification, examples and data provide a complete description of the system and use of the invention. Since many embodiments can be made without departing from the Spirit and Scope of the invention, the invention resides in the claims hereinafter appended.

What is claimed is:

1. A system for providing an online user with a transitory offline services for network and cloud based file systems and online services comprising:
a full service system;
a stashed service system; and
service provisioning logic system
wherein, the system functions by
receiving request from the user for a full service upon logging in by the user, by the full service system;
updating the user with the information about the mode of the service, to be received by the user;
receiving request from the user for full service, and continuing in the full service mode and providing the relevant services available in the full service mode to the user;
responding to the user's request, for a stashed service, with an error message;
and wherein
receiving request from the user for a stashed service upon logging in by the user, by the stashed service system;
updating the user with the information about the mode of the service, to be received by the user;
receiving request from the user for stashed service, and continuing in the stashed service mode and providing the relevant services available in the stashed service mode to the user;
responding to the user's request, for a full service, with an error message;
and wherein,
retaining the information and updating the user of the then available mode of the service system by the service provisioning logic.

2. The system of claim 1, wherein the said full service system has the option of transitioning to the stashed service and providing the user with stashed services.

3. The system of claim 1, wherein the said stashed service system has the option of transitioning to the full service and providing the user with full services.

4. The system of claim 2, wherein the full service system reverts to the stashed service upon successful authentication of the user's identity.

5. The system of claim 2, wherein the stashed service system reverts to the full services upon successful authentication of the user's identity.

6. The system of claim 2, wherein the authentication of the user's identity is through a multifactor authentication method.

7. The system of claim 1, wherein the stashed service mode, momentarily enables full service mode for executing a system-initiated transaction and upon updating the file system or online service, reverts back to the stashed service mode.

8. The system of claim 1, wherein the stashed service mode, caches requests from the user and any future requests and executes the transactions in a batch mode at a predetermined time of the day.

9. The system of claim 1, wherein the implementation of the said system is enabled through NFS mount.

10. The system of claim 1, wherein the implementation of the said system is provided through web services.

11. The system of claim 1, wherein the said full services and the said stashed services are provided using Virtual machines and wherein each of the services operate from two different virtual machines.

12. The system of claim 1, wherein the granularity of the said stashed services are provided to the user for its various implementations.
